(19) United States
(12) Patent Application Publication
(10) Pub. No.: US 2009/0142729 A1
(43) Pub. Date: Jun. 4, 2009

(54) Method and Releasably Connecting a Tool to a Dental Handpiece and Connection Between the Tool and Dental Handpiece

(76) Inventor: Stefan Neumeyer, Eschlkam (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/989,782

(22) PCT Filed: Jul. 29, 2006
(86) PCT No.: PCT/DE2006/001329

§ 371 Date: Jan. 31, 2008

(30) Foreign Application Priority Data
Aug. 3, 2005 (DE) 10 2005 036 466.7
Jun. 7, 2006 (DE) 10 2006 026 831.8
Jul. 24, 2006 (DE) 10 2006 034 658.0

(51) Int. Cl. A61C 3/03; A61C 1/08

(52) U.S. Cl. 433/119; 433/126; 433/215

(57) ABSTRACT

The invention relates to a method for establishing a releasable connection between a tool connection or coupling piece, which is formed on a dental handpiece, and the tool shank of a dental hand instrument. In order to connect a journal-like fastening section, which tapers toward a free end, on one of the elements to be connected, is inserted into an opening while matching the same, which is adapted to this section, on the other of the elements to be connected.

### BACKGROUND OF THE INVENTION

The invention relates to a method of releasably connecting a tool to a dental handpiece and the connection between the tool and the dental handpiece.

Especially for dental ultrasonic instruments or handpieces, the fastening of the respective tool (instrument tip) to the instrument or handpiece is problematic, since the transfer of the ultrasonic energy to the tool is maintained to the required degree only by means of an absolutely rigid connection of the tool to the connecting or coupling element of the instrument or handpiece. For this reason it has been standard practice in the past to implement the connection between the ultrasonic instrument or handpiece and the tool as a screw connection, which makes the process of connecting and releasing the tool unnecessarily complicated and time-consuming.

It is an object of the invention is to provide a method that enables an absolutely rigid connection of a tool to a instrument or handpiece.

### SUMMARY OF THE INVENTION

The adhesion between the dental instrument or handpiece and the tool and therefore in particular also the connection between the instrument or handpiece and the tool or tool shaft required for transfer of the ultrasonic energy is achieved by at least one journal-shaped mounting section that is tapered toward the free end, for example by a cone. The tool can be secured on the instrument or handpiece in a wide variety of manners, for example purely mechanically, e.g. through the connection of overlapping securing elements, by a bayonet-type connection and/or threaded interlocking, through a conical thread, by which locking takes place by turning by a maximum angle of 200°, preferably only by an angle of 120° or 180°, etc.

The tool can also be secured by form-changing elements, in particular also such elements that change their form under the influence of a magnetic field, through temperature influences, etc., for example elements that change their form by a bi-metal effect as a result of temperature influences. Further, such elements can also be used to increase the pressing forces in the connecting area and/or to change the angle of the taper.

To secure and/or increase the anchoring and pressing forces between the surfaces adjoining each other in the area of the connection and/or to improve the transfer of the ultrasonic energy, chemical means can also be used, for example chemical surface treatment, adhesive means, including films or glues, the use of fluids, in particular also such fluids with controllable viscosity and/or adhesive force and/or otherwise changeable chemical and/or physical properties.

Further, measures are preferably taken to achieve a torsionally rigid connection and/or a connection between the tool and the hand instrument that ensures a defined positioning of the tool on the instrument or handpiece. This can be achieved, for example, by making the connection by means of several projections or fastening or coupling sections that are tapered toward the end and/or by the at least one journal-shaped tapered fastening section having a profile that deviates from the circular form at least on a partial length, namely with an accordingly adapted seat or opening. This can be achieved, for example, by providing the at least one journal-shaped fastening section with at least one groove extending in the longitudinal direction of said section.

### BRIEF DESCRIPTION OF THE DRAWINGS

The invention is described in more detail below based on exemplary embodiments, in which:

FIGS. 1 & 2 each show a schematic representation as a partial section of a instrument or handpiece coupling element, together with a dental tool fastened to said coupling element;

FIG. 3 shows a similar depiction as in FIG. 1, however in a further embodiment;

FIG. 4-9 show very schematic depictions of further embodiments of the invention;

FIG. 10 shows a front view of the coupling section of the connection of FIG. 9; and

FIG. 11 shows a cross section through the coupling section of an embodiment of the invention.

### DETAILED DESCRIPTION OF THE INVENTION

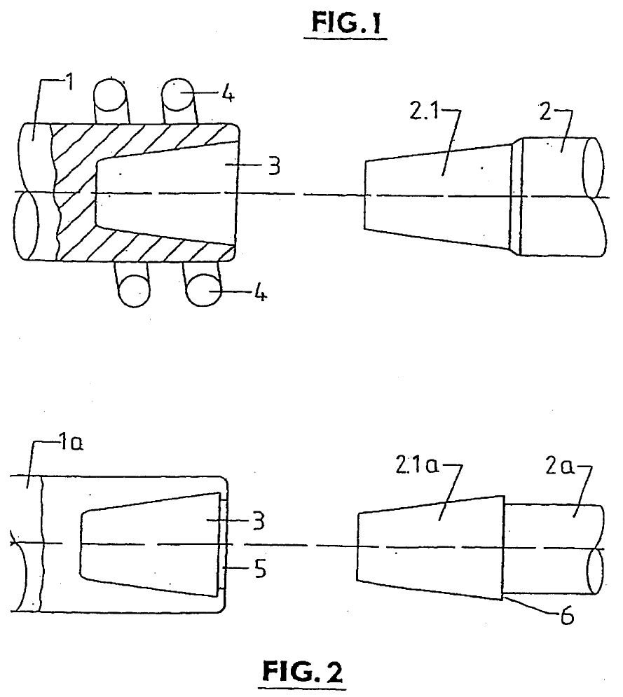

FIG. 1 shows a coupling element 1 provided or formed on a dental instrument or handpiece for connecting a dental tool, of which FIG. 1 shows only the shaft 2 and which comprises an electro-mechanical vibration generator, for example for generating vibrations between 5 and 10 kHz or also preferably in the ultrasonic range.

The coupling element 1 is accordingly the resonant body of an ultrasonic instrument or handpiece, which is driven by an electro-mechanical converter, for example by a magnetostrictive converter for an oscillating motion in the ultrasonic range, accommodated in the instrument or handpiece.

The coupling element comprises an opening 3 that is open toward a front side of said coupling element and arranged on the same axis or not on the same axis with the coupling element which is for example cylindrical on its outer surface, which (opening) starting from the open side toward the closed end is tapered slightly conically, and the cone angle α/2 depicted exaggeratedly in FIG. 1 is between 0.01 and 8 degrees, preferably between about 0.5 and 2 degrees. On the end to be connected to the coupling element 1 the tool shaft 2 is provided with a likewise tapered section 2.1, which is adapted to fit the opening 3 with regard to diameter, taper angle, etc., so that the tool shaft 2 is held so that it fits in the opening 3, in particular also if the coupling element 1 made of metal and the tool shaft 2, likewise made for example of metal or ceramic, both have the same temperature. The size of the cone angle is adapted for example to the frequency of the vibration generator and is also dependent on the materials used.

With the small taper angle α and cone angle α/2, the connection between the coupling element 1 and the tool or tool shaft 2 is possible by inserting the coupling section 2.1 into the opening 3, without danger of the section 2.1 slipping axially out of the opening 3 during operation.

The axial length of the cone surfaces used for the connection, i.e. the axial length of the coupling section 2.1 and also the axial length of the opening 3 accommodating said coupling section is at least 0.5 mm and not greater than 15 mm, for example. This makes it possible for these cone surfaces to be interrupted by shoulders, so that the axial total length of the individual cone surfaces corresponds to the total of the aforementioned values.

The cone surfaces to be connected with each other are surface-treated in a suitable manner, namely polished for example, e.g. high-gloss polished, so that the cone surfaces to be connected with each other, i.e. the cone surface of the coupling section 2.1 and the cone surface or inner surface of the opening 3 are designed so that they match very exactly. The cone surfaces in this regard are for example high-gloss polished and/or rolled, in which case not only a high-precision fit is achieved, but also a compression of the material on the cone surfaces at least in the surface area.

In principle, it is also possible to profile the opening 3 and/or the section 2.1 on their taper surfaces in a suitable manner, which for example can be achieved by roughening of the surface, by coating the surfaces with suitable materials that produce surface roughness, for example also with nano-technology and/or by producing grooves, recesses, etc. in the surfaces.

The roughness likewise depends on the frequency of the electromagnetic vibration generator and/or the materials used and/or the special design of the tool between 0.01 μm and 100 μm, while a wide variety of ranges of roughness are possible in combination, e.g. between 0.01 and 0.1 μm, between 0.1 and 1.0 μm, between 1.0 and 5 μm, between 5.0 and 20 μm and between 20 and 100 μm.

For the use of the tool shaft 2 with a coupling element 1, said coupling element or its opening 3 can be expanded according to a special embodiment of the invention by heating, so that after inserting the section 2.1 into the opening 3 and after the return of the coupling element 1 by cooling to the normal condition of the tool shaft 2, the entire tool is connected especially rigidly with the coupling element 1.

The expansion of the coupling element 3 and of the opening there is achieved by heating the coupling element 1, for example with ultrasound, through an electromagnetic coil 4 enclosing the coupling element 1 and generating an induction current in the coupling element 1 or through a heating coil enclosing the coupling element.

A material is then preferably used for the coupling element 1 that differs from the material of the coupling element 2.1 and has the maximum possible temperature expansion coefficient. To prevent the tool from being inserted too deep, a depth stop controls the final position.

The absolutely rigid seat of the tool shaft 2 in the coupling element 1 ensures optimum transfer of the ultrasonic energy from the instrument or handpiece to the tool connected with said instrument or handpiece, especially when the instrument or handpiece is designed as an ultrasonic instrument or handpiece.

To release the tool 2 or the coupling section 2.1 from the opening 3, the coupling element 1 is again heated. To ensure reliable release during this heating the coupling element 1 is made of a material having a higher heat expansion coefficient than the material of the shaft 2 or of the coupling section 2.1.

FIG. 2 shows as a possible embodiment a coupling element 1a, which differs from the coupling element 1 essentially in that the opening 3 is provided on its open side with a catch 5, namely in the depicted embodiment in the form of a ring-shaped projection concentrically enclosing the axis of the opening 3. The coupling section 2.1a of the tool shaft 2a in this embodiment is provided with a ring-shaped collar 6, which is engaged by the catch 5 when the tool or tool shaft 2a is fastened in the coupling element 1a. In this embodiment also the coupling element of the opening 3 is expanded by heating for connecting the shaft 2a, so that the coupling section 2.1a with the collar 6 can be pushed over the catch 5. After cooling of the coupling element 1a the coupling section 2.1a is not only anchored positively and rigidly in the opening 3, but is also additionally secured by the catch 5 engaging the collar 6.

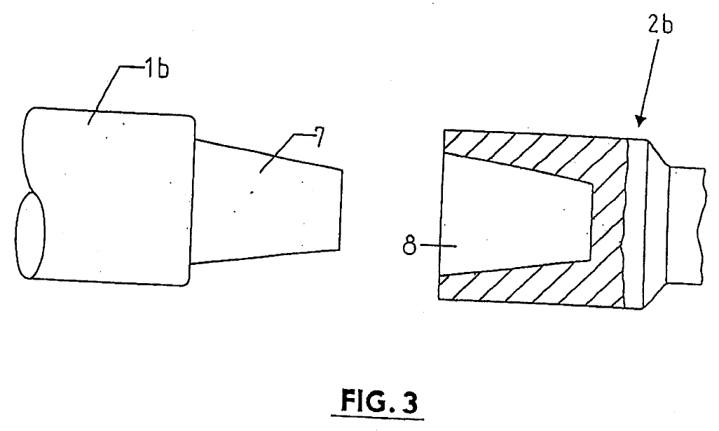

FIG. 3 shows as a further possible embodiment a instrument or handpiece coupling element 1b on which a tapered projection 7 is provided on which the respective tool can be placed with its tool shaft 2b or with an opening 8 there that is adapted to the shape and size of the projection 7. In this embodiment the tool or the tool shaft 2b is heated prior to fastening, therefore enlarging the opening 8, so that after cooling, an absolutely rigid connection between the tool and the coupling element 1b is achieved by shrinking. To remove the tool, the tool shaft 2b is again heated to expand the opening 8, so that the tool can then be removed from the coupling element or the projection 7.

In the embodiment of FIG. 3 the previously described means for additional axial securing, for example roughening of the contacting surfaces between the coupling element and the tool shaft 2b, additional catches, etc. can likewise be provided.

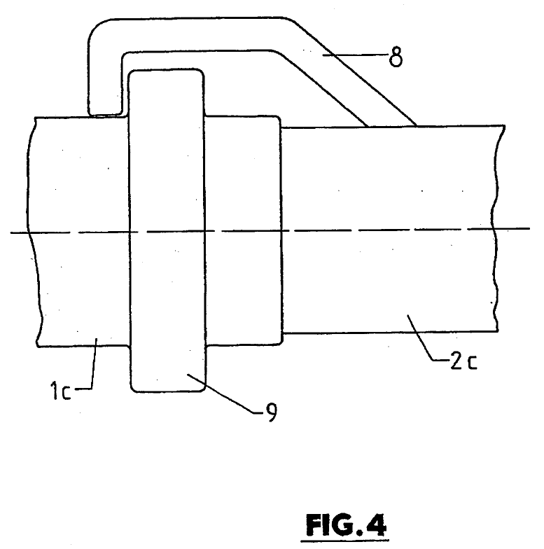

FIG. 4 shows in a very simplified schematic depiction and in side view the instrument or handpiece coupling element 1c together with the tool shaft 2c releasably fastened to said coupling element. To secure the tool shaft 2c and therefore the tool on the instrument or handpiece a securing hook 9 is provided which bridges the connecting area between the coupling element 1c and the tool shaft 2c, i.e. on the one hand is held on the tool shaft 2c, for example so that it can pivot, and on the other hand positively engages with its other end, in secured state, the coupling element 1c, for example in the area of a ring-shaped bulge 10.

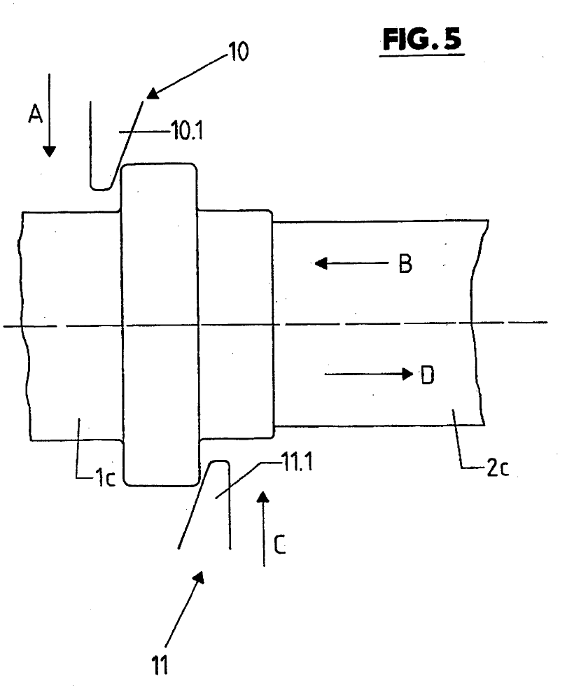

FIG. 5 again shows, in a depiction similar to FIG. 4, the coupling element 1c and the tool shaft 2c, together with a partial view of a pressing tool 11. The pressing tool is designed for example similarly to the securing hook 9, so that this pressing tool 11 applied to the tool shaft 2c engages with the bulge 10 with a partial surface or with a section 11.1 to press the tool shaft or the coupling section of said tool shaft into the opening of the coupling element 1c, so that when the pressing tool 11 is moved in the direction of the axis of the coupling element in the tool shaft 2c is pressed corresponding to arrow B into the opening of the coupling element. Further, a tool 12 for releasing the tool shaft 2c from the coupling element 1c is depicted. This tool 12 likewise engages with the section 12.1 with the bulge 10, in this case with the side of the bulge 10 facing the tool shaft 2c, so that when the section 12.1 is moved corresponding to arrow D in the direction of the arrow C, i.e. in the direction of the axis of the coupling element 1c along the bulge 10, a force is exerted for releasing the tool shaft 2c.

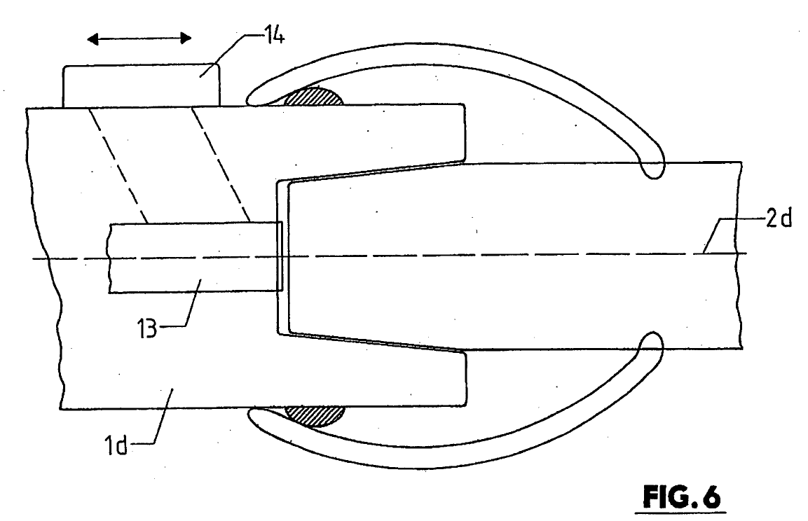

FIG. 6 shows an embodiment in which the transition between the coupling element 1d and the tool shaft 2d is covered by a sleeve 13 made of a rubber elastic material, for example by a silicon sleeve 13. To release the tool shaft 2d from the coupling element 1d, an axially moveable ram 14 is provided in said coupling element, which (ram) can be moved via a manually controllable slide 15 provided on the outer surface of the coupling element 1d, so that said ram 14 is moved into the opening 3 of the coupling element 1d, therefore releasing the tool shaft 2d from the coupling element.

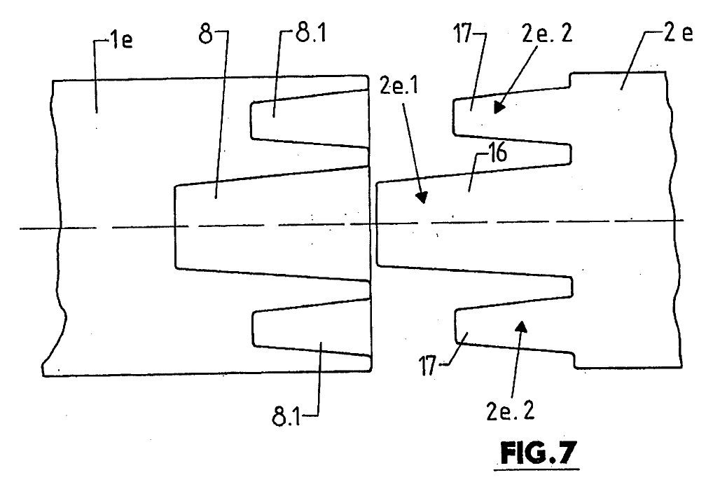

FIG. 7 shows an embodiment in which the releasable connection between the coupling element 1e and the tool shaft 2e is achieved by a coupling section 2e.1, which likewise is formed by a tapered projection 16, and by several further coupling sections 2e.2, which likewise are formed by tapered projections 17. The projections 17 are radially offset from the projection 16 and provided in a distributed array around the projection 16. The projection 16 corresponds to a tapered opening 8 adapted to the shape of said projection on the coupling element 1e and each projection 17 corresponds to an opening 8.1 adapted to the shape of said projection. The projection 17 and the corresponding openings 8.1 enable a torsionally rigid connection between the tool shaft 2e and the coupling element 1e, said connection being exactly oriented with respect to the angular position on the axis of the journal 16.

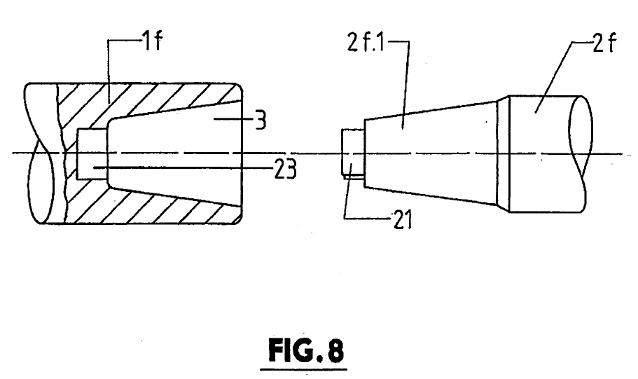

FIG. 8 shows an embodiment in which a front-side extension 21 is provided on the coupling section 2f.1, likewise formed by a tapered projection or journal 20, which (extension) exhibits a cross section deviating from circular and to which a recess 23 corresponds on the bottom of the opening 22 adapted to the form of the journal 20. The cross section of the recess 23 is adapted to the cross section of the extension 21, so that a connection between the tool shaft 2f and the coupling element 1f is possible only in one or more pre-defined angular positions.

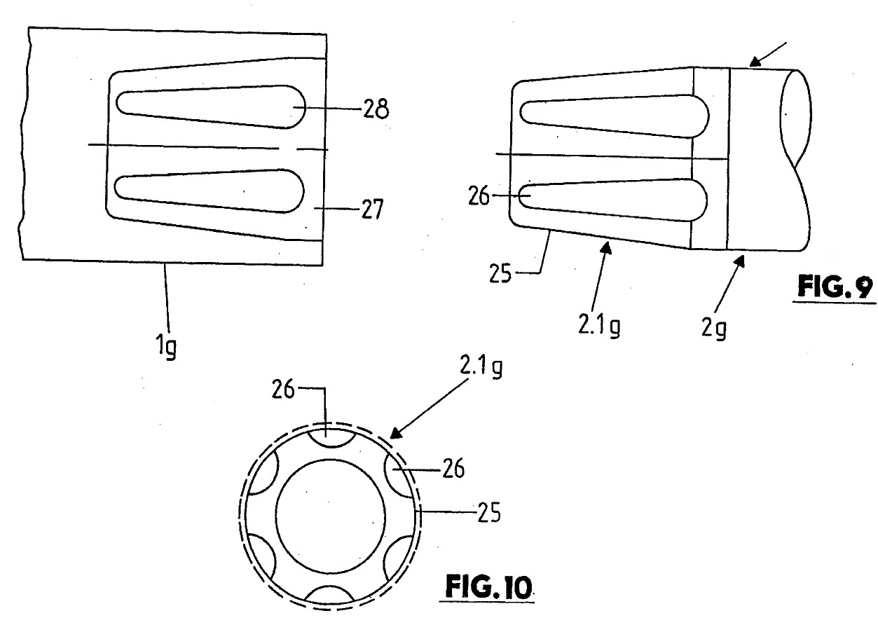

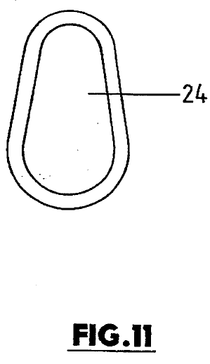

FIGS. 9 and 10 show an embodiment in which the coupling section 2g.1 is likewise formed by a tapered journal 25, which comprises on its circumferential or peripheral surface several grooves 26, each extending in a surface line. A recess or opening 27 is provided in the coupling element 1g, the shape of which (opening) is adapted to the shape of the journal 25, i.e. likewise tapered and comprising projections 28 that fit into the grooves 26.

In principle it is possible with this embodiment to provide grooves instead of projections 28 in the recess 27, into which (grooves) projections engage that are provided instead of the grooves 26 on the coupling section 2.1g. The grooves and the projections adapted to said grooves produce a torsionally rigid connection between the instrument or handpiece or coupling element 1g and the tool shaft 2g. The distribution of the grooves 26 and the projections 28 also enables coding, e.g. in the form that the tool can be fastened in the instrument or handpiece only in a pre-defined position, and this position can differ from tool to tool or from tool type to tool type, and/or that only certain tools can be used on a instrument or handpiece.

FIG. 11 shows a very schematic depiction of a cross section through a journal 24 forming a coupling element, which (journal) although likewise tapered toward its free end, is not rotationally symmetrical to a journal axis, so that this journal form alone and the corresponding form of the corresponding opening receiving the journal 24 when connected can achieve a torsionally rigid releasable connection between the coupling element on the instrument or handpiece and the tool shaft, in addition to a unique angular position.

The invention was described above based on exemplary embodiments. It goes without saying that numerous modifications and variations are possible without abandoning the underlying inventive idea on which the invention is based. Especially for such tools which can be operated under pressure, even with a larger taper angle α, additional means for axially securing the connection between the tool and the coupling element are not necessary.

Further, it is also possible, instead of the described means for additional axial securing of the connection or in addition to these means, to provide mechanical locking means, which in secured state engage with a surface on the respective tool shaft and therefore prevent the release of the tool shaft from the coupling element.

### REFERENCE LIST

1, 1a, 1b, 1c, 1d, 1e, 1f, 1g coupling element
2, 2a, 2b, 2c, 2d, 2e, 2f, 2g tool shaft
2.1, 2.1a, 2.1e, 2.1f, 2.1g coupling section
3 opening
4 electric coil
5 catch
6 collar
7 projection
8 opening
9 securing tool
10 bulge
11 pressing tool
11.1 tool section
12 releasing tool
12.1 tool section
13 covering sleeve
14 ram
15 slide
16, 17 projection or journal
18, 19 opening
20 projection or journal
21 journal extension
22 opening
23 recess
24, 25 projection or journal
26 groove
27 opening
28 projection
A, C movement of the tool
B, D direction of force

What is claimed is:

1. A method for releasably connecting a tool connection or a coupling element on a dental tool to a tool shaft of a dental instrument or handpiece, for making a connection, a journal-shaped coupling or fastening section, which is tapered toward a free end, on one of the elements to be connected is inserted in an opening on the other of the elements to be connected so that the journal-shaped coupling or fastening section fits into said opening, which is adapted to the journal-shaped coupling or the fastening section.

2. The method according to claim 1, wherein the opening and/or the fastening section or at least one projection or journal forming said section are at least partially polished on the surfaces that are in contact with each other after connecting.

3. The method according to claim 1, wherein the opening and/or the fastening section are at least partially profiled, with roughening, on the surfaces that are in contact with each other after connecting.

4. The method according to claim 1, wherein engaging catches are provided in an area of the opening and on the fastening section.

5. The method according to claim 1, wherein an angle (α/2) formed by a circumferential surface of the fastening section or of the at least one journal with an axis of the fastening section is selected based or depending on a frequency of a vibration generator or on a material composition.

6. The method according to claim 5, wherein the angle (α/2) is between 0.01 and 8.0 degrees.

7. The method according to claim 5, wherein the angle (α/2) is between 0.25 and 2.0 degrees.

8. The method according to claim 1, wherein after connecting, a roughness on the contacting surfaces of the opening and/or or of the fastening section is between 0.01 μm and 100 μm.

9. The method according to claim 1, wherein after connecting, an axial length of the contacting surfaces of the opening and/or or of the fastening section is between 0.5 mm and 15 mm.

10. The method according to claim 1, wherein at least one additional securing element or of a securing or covering sleeve is used between the coupling element and the tool shaft connected with said element.

11. The method according to claim 1, further comprising means acting between the coupling element and the tool shaft for connecting and releasing the tool shaft with and from the coupling element, respectively.

12. The method according to claim 1, wherein the dental instrument or handpiece is a sonic or ultrasonic instrument or handpiece.

13. The method according to claim 1, wherein before connecting, the coupling element comprising the opening and/or the tool shaft comprising the opening is heated.

14. The method according to claim 13, wherein the heating takes place by ultrasound or by electric induction or by at least one heating coil.

15. A releasable connection a dental instrument or handpiece and a tool shaft of a dental tool, comprising at least one fastening or connecting section which is tapered toward one free end, on one of the elements to be connected, which can be inserted so that the connection fits into an opening, which is adapted to said section and provided on the other of the elements to be connected.

16. The connection according to claim 15, wherein the fastening or connecting section is formed by at least one projection or journal.

17. The connection according to claim 15, wherein the opening or the fastening section are at least partially polished on the surfaces that are in contact with each other after connecting.

18. The connection according to claim 14, wherein the opening and/or or the fastening section are at least partially profiled, provided with roughening or micro-profiling, on the surfaces that are in contact with each other after connecting.

19. The connection according to claim 14, further comprising mutually engaging catches provided in an area of the opening and on the fastening section.

20. The connection according to claim 14, wherein an angle (α/2) formed by a circumferential surface of the fastening section or of the at least one journal with an axis of the fastening section is selected based on a frequency of the vibration generator or on a material composition.

21. The connection according to claim 20, wherein the angle (α/2) is between 0.01 and 8.0 degrees.

22. The connection according to claim 20, wherein the angle (α/2) is between 0.25 and 2.0 degrees.

23. The connection according to claim 15, wherein after connecting, a roughness on contacting surfaces of the opening or of the fastening section is between 0.01 μm and 100 μm.

24. The connection according to claim 15, wherein after connecting, an axial length of the contacting surfaces of the opening or of the fastening section is between 0.5 mm and 15 mm.

25. The connection according to claim 15, further comprising at least one additional securing element or of a securing or covering sleeve between the coupling element and the tool shaft connected with said element.

26. The connection according to claim 15, further comprising means acting between the coupling element and the tool shaft for connecting and releasing the tool shaft with and from the coupling element, respectively.

27. The connection according to claim 15, wherein the element comprising the opening at least in the area of said opening is made of a heatable material, which has a higher heat expansion coefficient than a material of a fastening section.

28. The connection according to claim 15, wherein the dental instrument or handpiece is a sonic or ultrasonic instrument or handpiece.

29. The connection according to claim 15, wherein a fastening or connecting section or at least one projection or journal forming the fastening or connection section is conical or tapered.

30. The connection according to claim 29, wherein the fastening or connecting section or the projection or journal forming said section at least on a partial length has a form that deviates from a rotationally symmetrical form or a form with cross sections that deviate from a circular form.

31. The connection according to claim 29, wherein the fastening or connecting section or the projection or journal forming said section is a conical journal or a symmetrical or asymmetrical non-round form with a surrounding sleeve, round or non-round, but with a conical or non-conical cross section.

32. The connection according to claim 15, wherein the connecting section is a connecting system, which consists of several forms.

33. The connection according to claim 15, wherein the fastening or connecting element consists of at least two projections or journals.

34. The connection according to claim 16, wherein the at least one projection or journal comprises on its journal end a section or extension with a cross section deviating from a circular form or with a form that deviates from a rotationally symmetrical form, and that a depression or recess that is adapted to the cross section and/or or the form of the extension is provided on a bottom of the opening.

35. The connection according to claim 15, further comprising means for securing the connection or improving pressing forces between opposite contacting surfaces of the connection.

36. The connection according to claim 35, wherein the means for securing the connection or improving the pressing forces are mechanical means, in the form of a thread, a conical thread, or in the form of a bayonet-type locking mechanism or in the form of elements with a changeable form.

37. The connection according to claim 35, wherein the means for securing the connection or improving the pressing forces are chemical means, adhesives or glues or chemical in form or means with changeable properties.

38. The connection according to claim 35, wherein the means for securing the connection or improving the pressing forces are formed by a surface structure of the opposite contacting surfaces of the connection.

39. The connection according to claim 15, wherein the at least one fastening or connecting section and the at least one opening adapted to said section are profiled corresponding to the connecting or fastening section.

40. The connection according to claim 39, wherein the profiling is formed by at least one groove-shaped recess and a matching projection.
